(19) United States
(12) Patent Application Publication
(10) Pub. No.: US 2006/0120212 A1
(43) Pub. Date: Jun. 8, 2006

(54) Stirring and mixing device

(75) Inventors: Toru Taniguchi, Miyazaki-gun (JP); Nobuaki Fujioka, Miyazaki-gun (JP)

Correspondence Address: OLIFF & BERRIDGE, PLC, P.O. BOX 19928, ALEXANDRIA, VA, 22320, US

(73) Assignee: Reika Kogyo Kabushiki Kaisha, Miyazaki-gun (JP)

(21) Appl. No.: 11/290,609

(22) Filed: Dec. 1, 2005

(30) Foreign Application Priority Data
Dec. 7, 2004 (JP) 2004-354736
Jul. 28, 2005 (JP) 2005-219673

(51) Int. Cl. B01F 11/00; B01F 15/02

(52) U.S. Cl. 366/118; 366/156.2; 366/172.1; 366/289

(57) ABSTRACT

A stirring and mixing device 110 comprises an introduction pipe 55 which is provided with a powder introduction port 24 and a liquid introduction port 22, an extrusion pipe 60 which is connected to the introduction pipe 55 and extrudes a mixture of powder and liquid introduced through the introduction pipe 55 to its one end portion, a casing 12 which is connected to one end portion of the extrusion pipe 60 and provided with a passage through which a fluid of the extruded mixture is made to flow, and a stirrer 15 which is disposed within the casing 12 and comprised of a shaft portion 14 connected to a drive source 20 and a stirring blade 16 attached to the external surface of the shaft portion 14. A funnel-shaped powder introducing device 57 is attached to the powder introduction port 24, a feeder 54 for conveying powder is disposed in the powder introducing device 57, and the feeder 54 is connected to an oscillatory rotation drive source 53.

The entire disclosures of Japanese Patent Application Nos. 2004-354736 and 2005-219673, including specification, claims, drawings and abstract are incorporated herein by reference in their entirety.

### BACKGROUND OF THE INVENTION

1. Field of the Invention

The present invention relates to a stirring and mixing device which introduces powder by rotating a feeder in an oscillatory manner for conveying the powder, and stirs and mixes with liquid.

2. Description of the Related Art

For example, it is known that where liquid is added to mix with powder, powder is added to mix with liquid, or powder and liquid are simultaneously added to mix them, secondary aggregated particles (so-called undissolved lumps) of the powder are produced in the liquid, and it is quite difficult to disperse the formed secondary aggregates into the liquid again. In addition, the secondary aggregates block a raw material introduction port, resulting in readily causing a phenomenon that later introduction of powder becomes difficult.

Accordingly, there have recently been proposed devices and methods capable of suppressing secondary aggregation from occurring when powder and liquid are mixed.

Japanese Patent Laid-Open Publications No. Hei 11-19495, No. 2001-62273 and No. 2002-166154 propose a continuous mixing device for liquid and powder, wherein a rotating disk is disposed in a casing, which is provided with a supply port for liquid and powder located in an upper part and a discharge port in a lower part, to divide the casing interior into an upper kneading chamber and a lower kneading chamber, a scraper is fitted to an upper part of the rotating disk, and a rotating scraper which rotates independently in a non-contact state from the rotating disk is attached below the rotating disk, the powder and liquid charged through the supply port are mixed by rotating the rotating disk, and the mixture which is moved to the lower kneading chamber is mixed and scraped by the rotating scraper, which rotates at a speed lower than that of the rotating disk, and continuously discharged through the discharge port.

Japanese Patent Laid-Open Publications No. 2002-248330 and No. 2001-198447 propose a continuous mixing device for mixing powder and liquid by means of a rotating mixing disk, wherein the liquid is supplied by spraying, and the powder and the liquid are mixed uniformly.

Japanese Patent Laid-Open Publication No. 2001-65850 proposes a method of mixing powder such as coal powder and liquid such as water to prepare a slurry, which comprises feeding the powder into a screw pump, supplying the liquid from a midpoint of the screw pump to mix the powder and the liquid, raising pressure, and lowering the pressure at the discharge port of the screw pump to form the slurry.

In addition, the present inventor has proposed in Japanese Patent Laid-Open Publication No. 2000-246131 a dispersing device which has a casing for housing two or more kinds of materials therein and a rubber disposed within the casing, wherein irregularities are formed on at least one of the inside surface of the casing or the outside surface of the rubber, the casing and the rubber are reciprocally moved relative to each other, and at least one kind of material among the two or more kinds of materials is dispersed by a compression pressure produced in the gap between the inside surface of the casing and the outside surface of the rubber.

However, none of the above-described mixing devices and mixing methods can prevent the powder introduction port from being blocked by completely remedying the occurrence of the secondary aggregation, and a combination of powder and liquid mixable is limited. Thus, they is still scope for improvement.

According to the above-described mixing devices and mixing methods, when a substance is obtained by mixing, dissolving, chemical reaction, polymerization reaction or the like of liquid, and the liquid has high viscosity, there is a possibility that the mixing will be insufficiently uniform.

Specifically, in a portion where powder and liquid are joined in the vicinity of the powder introduction port, the liquid comes into direct or indirect contact with the powder in the vicinity of the powder introduction port. Therefore, the powder absorbs moisture in the vicinity of the powder introduction port to produce secondary aggregation, possibly resulting in blocking the powder introduction port. Also, it becomes difficult to continuously perform a stirring and mixing operation.

Accordingly, the present invention provides a stirring and mixing device that suppresses the occurrence of secondary aggregation in a combination of powder and liquid, prevents a raw material introduction port from being blocked by the secondary aggregation, is rich in versatility without substantially limiting a combination of mixing liquid and liquid and a combination of powder and liquid, and is excellent from the point of view of uniform mixing, reaction and the like of liquid and liquid, and also powder and liquid.

### SUMMARY OF THE INVENTION

The stirring and mixing device of the present invention has the following features.

(1) The stirring and mixing device has an introduction pipe which is provided with a powder introduction port, at least one liquid introduction port which is disposed below the vicinity of the powder introduction port, a feeder which conveys powder and a mixture of powder and liquid, and an oscillatory rotation source which rotates the feeder in an oscillatory.

The liquid introduction port is disposed below the vicinity of the powder introduction port, so that the introduced powder can be dispersed and smoothly dropped downward.

(2) In the stirring and mixing device described in (1) above, the feeder is provided with a powder delivery screw blade at least at the position of the liquid introduction port or below the position of the liquid introduction port, and the powder delivery screw blade has a size such that its side end portion reaches the vicinity of the inside wall of the introduction pipe.

The powder delivery screw blade can smoothly deliver the powder downward without disrupting the flow of the powder in the introduction pipe.

(3) In the stirring and mixing device described in (1) or (2) above, the feeder is provided with at least one cutting blade for cutting the mixture of powder and liquid.

The cutting blade makes it possible to convey the mixture smoothly through the introduction pipe by dividing the mixture into appropriate sizes.

(4) In the stirring and mixing device described in any of (1) through (3) above, an overflow port is further disposed below the powder introduction port and above the liquid introduction port.

Even if a powder introduction amount and/or a liquid introduction amount exceeds the conveying ability of the introduction pipe, there is no possibility of the mixture of powder and liquid overflowing to flow back through the powder introduction port. Thus, the powder introduction port is prevented from being blocked by the mixture, and the powder can be continuously introduced in a stable manner.

(5) The stirring and mixing device described in any of (1) through (4) above further comprises an extrusion pipe which is connected to the introduction pipe and extrudes the mixture of powder and liquid, which is introduced through the introduction pipe, to one end portion, a casing which is connected on one end portion of the extrusion pipe and provided with a passage through which a fluid of the extruded mixture is made to flow, and a stirrer which is disposed in the casing and comprised of a shaft portion connected to an oscillation source and a stirring blade fitted to the external surface of the shaft portion.

As described above, by the oscillatory rotation of the feeder, even if the introduced liquid comes in contact with the powder in the vicinity of the powder introduction port and a deposit due to secondary aggregation of the powder and the liquid adheres to the feeder in the vicinity of the powder introduction port of the introduction pipe, the deposit can be removed from the feeder. In addition, the secondary aggregate can be introduced anytime or continuously into the introduction pipe through the powder introduction port by the oscillatory rotation of the feeder. Thus, lumps of the secondary aggregate can be prevented from increasing in size with time, and the powder introduction port can be prevented from being blocked by a very-large secondary aggregate. Also, the aggregate of the mixture of the powder and the liquid introduced through the introduction pipe is extruded from the extrusion pipe into the casing, so that the mixture is conveyed anytime or continuously into the casing without depositing and then stirred and mixed. Thus, a fluid of the uniform mixture free from a secondary aggregate can be obtained.

(6) In the stirring and mixing device described in (5) above, the feeder is further comprised of a first shaft portion and a second shaft portion, and the oscillatory rotation drive source is comprised of a rotation source which rotates the first shaft portion and an oscillation source which oscillates the second shaft portion.

(7) In the stirring and mixing device described in (5) or (6) above, at least one stirring chamber is disposed within the casing by dividing the passage with a partition plate.

The disposition of the partition plate causes a turbulent flow in the passage of the casing to further improve the stirring efficiency.

(8) In the stirring and mixing device described in any of (5) through (7) above, the casing is further provided with a discharge port, and a filter for filtering the content of the casing is disposed in the vicinity of the discharge port.

The disposition of the filter makes it possible to obtain a desired dissolved material, mixture, reactant or the like by filtering undissolved material and unnecessary material.

(9) The stirring and mixing device described in any of (5) through (8) above further comprises at least one steam introduction port for introducing steam into the casing.

(10) In the stirring and mixing device according to any of (5) through (9) above, the mixture introduced into the casing is heated and/or dissolved and/or sterilized by adjusting an amount of steam and/or pressure of steam.

(11) In the stirring and mixing device described in any of (5) through (10) above, viscosity or reaction of the mixture is adjusted by adjusting the amount of steam and/or the pressure of steam.

(12) The stirring and mixing device described in any of (5) through (11) above further comprises at least one liquid introduction port through which the liquid is introduced into the casing.

The disposition of the liquid introduction port for introducing the liquid into the casing makes it possible to dilute the mixture introduced into the casing, adjust its viscosity and adjust its reaction.

(13) In the stirring and mixing device described in (12) above, the viscosity or reaction of the mixture is adjusted by adjusting the amount of liquid to be introduced.

### BRIEF DESCRIPTION OF THE DRAWINGS

Preferred embodiments of the present invention will be described in detail based on the following figures, wherein:

FIG. 1 is a sectional general view showing an example of the structure of a stirring and mixing device according to the present invention;

FIG. 2 is a sectional general view showing a structure of a drive source of a feeder of a powder introducing device which is connected to the stirring and mixing device shown in FIG. 1;

FIG. 3 is a sectional general view showing a structure of another drive source of the feeder of the powder introducing device which is connected to the stirring and mixing device shown in FIG. 1;

FIG. 4 is a sectional general view showing a structure of another drive source of the feeder of the powder introducing device which is connected to the stirring and mixing device shown in FIG. 1;

FIG. 5 is a sectional general view showing a structure of another drive source of the feeder of the powder introducing device which is connected to the stirring and mixing device shown in FIG. 1;

FIG. 6 is a sectional schematic view illustrating the construction of another embodiment of introduction of powder and liquid of the stirring and mixing device shown in FIG. 1;

FIG. 7 is a sectional view taken along line A-A′ of FIG. 6;

FIG. 8 is a schematic view illustrating another structure of the feeder in the structure of an introduction pipe shown in FIG. 6;

FIG. 9 is a schematic view illustrating another structure of the feeder in the structure of the introduction pipe shown in FIG. 6; and

FIG. 10 is a schematic view illustrating another structure of the introduction pipe of the stirring and mixing device shown in FIG. 6.

### DESCRIPTION OF THE PREFERRED EMBODIMENTS

Preferred embodiments of the present invention will now be described with reference to the drawings.

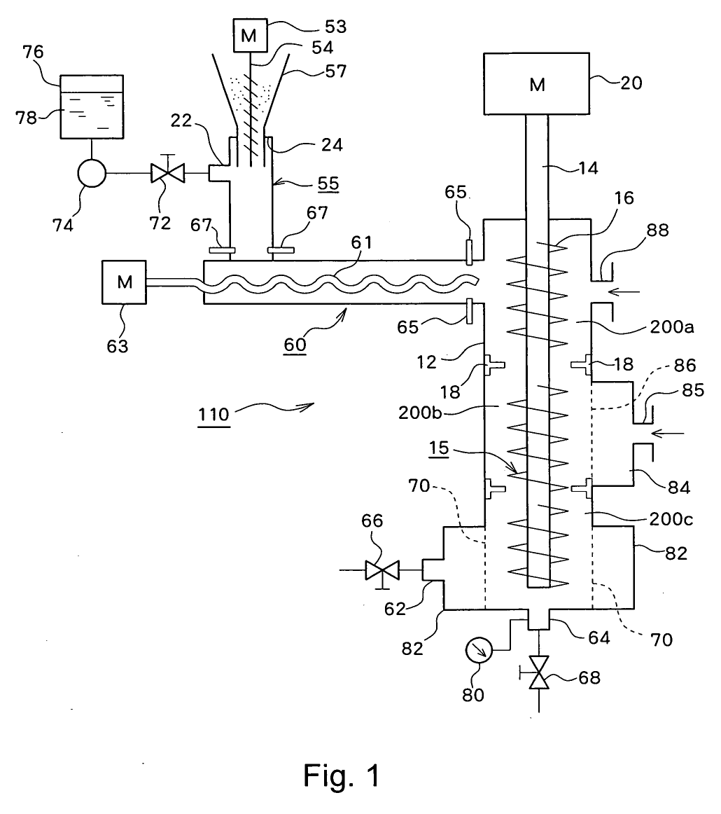

One example of the stirring and mixing device of the present invention will be described for its structure with reference to FIG. 1.

A stirring and mixing device 110 has an introduction pipe 55 which is provided with a powder introduction port 24 and a liquid introduction port 22, an extrusion pipe 60 which is connected to the introduction pipe 55 and extrudes a mixture of powder and liquid introduced through the introduction pipe 55 to its one end portion, a casing 12 which is connected to one end portion of the extrusion pipe 60 and provided with a passage through which a fluid of the extruded mixture is made to flow, and a stirrer 15 which is disposed within the casing 12 and comprised of a shaft portion 14 connected to a drive source 20 and a stirring blade 16 attached to the external surface of the shaft portion 14. A funnel-shaped powder introducing device 57 is attached to the powder introduction port 24, a feeder 54 for conveying the powder is disposed in the powder introducing device 57, and the feeder 54 is connected to an oscillatory rotation drive source 53.

The construction of the stirring and mixing device 110 will be described in detail.

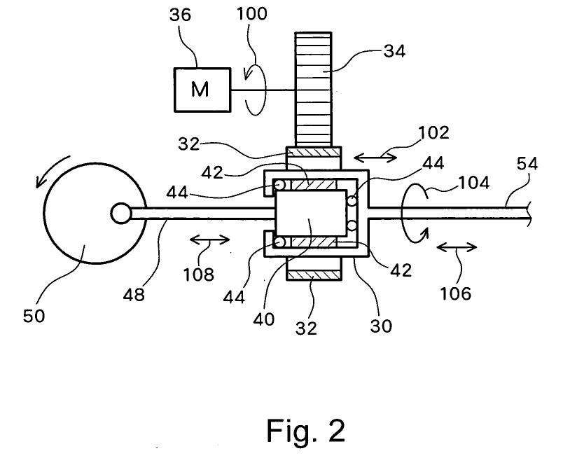

As described above, the introduction pipe 55 is provided with the powder introduction port 24 and the liquid introduction port 22. To the liquid introduction port 22 is connected a liquid storage tank 76 via a valve 72 and a pump 74, and mixing liquid 78 is stored in the liquid storage tank 76. The funnel-shaped powder introducing device 57 is connected to the powder introduction port 24, and the funnel-shaped discharge port of the powder introducing device 57 is protruded so as to be inserted into the introduction pipe 55. Here, the powder introduction port 24 and the liquid introduction port 22 are preferably close to each other. Thus, powder and liquid can be mixed anytime or continuously at a prescribed ratio. The powder introducing device 57 is provided with the feeder 54 for conveying the powder, and the feeder 54 is connected to the oscillatory rotation drive source 53. The oscillatory rotation drive source 53 will be described later with reference to FIG. 2 through FIG. 5.

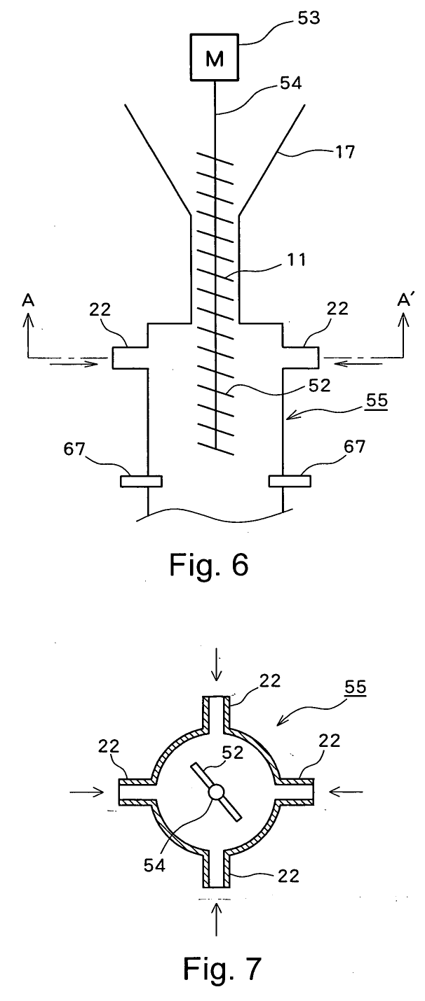

FIG. 1 shows that the introduction pipe 55 and the powder introducing device 57 are separately configured but not limited to such a configuration. For example, the introduction pipe 55 and the powder introducing device 57 shown in FIG. 1 may be configured into one body as shown in FIG. 6 through FIG. 9. Specifically, the introduction pipe 55 may be provided with a funnel-shaped powder introduction port 17 on its top end as shown in FIG. 6. The oscillatory rotation portion 53 which rotates the feeder 54 in an oscillatory manner for conveying the powder is disposed above the funnel-shaped powder introduction port 17. The feeder 54 is provided with a screw blade 11 and a powder delivery screw blade 52. The powder delivery screw blade 52 is desirably disposed at least at the position of the liquid introduction port 22 or below it. In FIG. 1, the feeder 54 is also provided with a blade. The introduction pipe 55 is provided with the liquid introduction port 22 on its side surface. As described above, the liquid introduction port 22 is preferably disposed below the vicinity of the powder introduction port 17. The disposition of the liquid introduction port 22 below the vicinity of the powder introduction port 17 makes it possible to drop the powder with the liquid. Thus, powder introduction efficiency is improved, and the powder can be prevented from rising.

A sectional view taken along line A-A′ of FIG. 6 is shown in FIG. 7. As shown in FIG. 7, the liquid introduction port 22 is formed at four positions on the side surface of the introduction pipe 55 but not limited to them. The liquid introduction port 22 is preferably disposed in at least one and more positions, and more preferably in two or more positions opposing each other. It is more preferable that the liquid is injected through the liquid introduction ports 22.

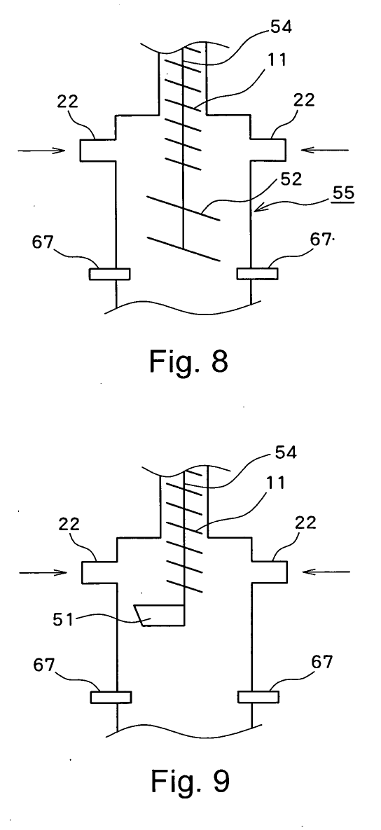

As shown in FIG. 8, the pitch between the individual powder delivery screw blades 52 disposed on the feeder 54 may be varied. For example, it may be configured as shown in FIG. 8 such that the pitch between the individual powder delivery screw blades 52 from the powder charging position of the powder introduction port 17 to the vicinity of the liquid introduction port 22 is made narrow to introduce powder continuously, while the pitch between the individual powder delivery screw blade 52 of the feeder 54 is made wide below the liquid introduction port 22 where powder and liquid are encountered, to convey a mixture of powder and liquid downward at anytime. Thus, the powder and the mixture can be conveyed smoothly at the same time.

As shown in FIG. 9, a cutting blade 51 may be disposed at the bottom end of the feeder 54. For example, the disposition of the cutting blade 51 below the vicinity of the liquid introduction port 22 makes it possible to cut the mixture of the liquid, which is introduced through the liquid introduction port 22, and powder, which has just encountered with the introduced liquid, into masses having an appropriate size. As a result, the mixture can be conveyed smoothly through the introduction pipe 55. The oscillatory rotation source may be set to have an increased oscillatory rotation speed if the mixture tends to form undissolved lumps of the mixture depending on the properties of the powder and liquid to be mixed or a decreased oscillatory rotation speed if the mixture has fluidity.

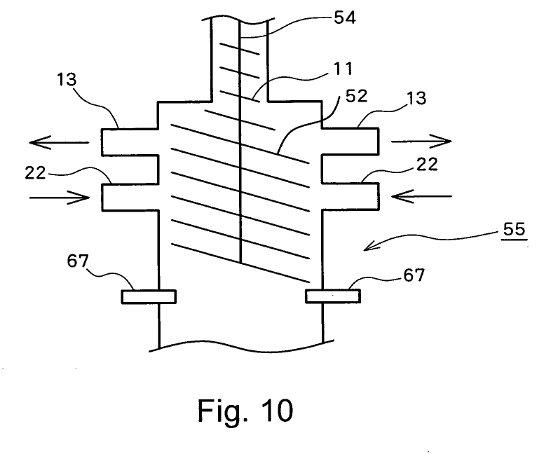

As shown in FIG. 10, the introduction pipe 55 may be provided with an overflow port 13 below the powder introduction port 17 shown in FIG. 6 and above the liquid introduction port 22. Even if a powder introduction amount and/or a liquid introduction amount exceeds the conveying ability of the introduction pipe, the mixture of the powder and the liquid can be prevented from overflowing and flowing back through the powder introduction port. In addition, the powder introduction port can be prevented from being blocked due to the backflow through the powder introduction port, so that the powder can be continuously introduced in a stable manner. Even if the mixture of the powder and the liquid is introduced into an extrusion pipe 60 through the introduction pipe 55 in an amount exceeding the conveying ability of the extrusion pipe 60 connected to the introduction pipe 55 shown in FIG. 1, the mixture has no possibility of flowing back to the powder introduction port because the introduction pipe 55 is provided with an overflow port 13. Therefore, the powder introduction port can be prevented from being blocked.

As shown in FIG. 10, the powder delivery screw blade 52 of the feeder 54 is formed to have a size such that its side end portion reaches the vicinity of the inside wall of the introduction pipe 55. Thus, the powder and the powder-liquid mixture are free from depositing on the inside wall of the introduction pipe 55 and can be continuously conveyed smoothly as a result.

The introduction pipe 55 is connected to the extrusion pipe 60 via a flange 67. In this embodiment, a Mohno pump is used as the extrusion pipe 60. Specifically, an external screw-shaped rotor 61 connected to a motor 30 is disposed within the extrusion pipe 60. As the Mohno pump, for example, a “NEMO® pump” of HEISHIN Ltd. may be used.

The extrusion pipe 60 is connected to the casing 12 via the flange 65. The casing 12 is formed therein a passage through which the fluid flows, and the casing 12 has therein the stirrer 15 which is comprised of the shaft portion 14 connected to the drive source 20 and the stirring blade 16 attached to the external surface of the shaft portion 14. The stirring blade preferably has a spiral shape, a rod shape, or the like selected appropriately depending on the raw materials to be stirred.

In this embodiment, the extrusion pipe 60 is connected upstream of the casing 12.

At least one partition plate 18 is disposed within the casing 12 and the passage to enable continuous flow of the fluid or the powder, and the casing 12 divided by the partition plate 18 has stirring chambers 200a, 200b, 200c into which mixtures having a different stirring degree are introduced continuously. As described above, the division of the interior of the casing 12 by the partition plate 18 enhances a turbulent flow effect. However, it is not essential to use the partition plate 18, and if stirring and mixing can be performed easily depending on the properties of the raw materials, the partition plate 18 is not required.

The upstream stirring chamber 200a in the casing 12 is provided with a steam introduction port 88, the stirring chamber 200b is provided with a steam introduction chamber 84, and a filter 86 is disposed between the steam introduction chamber 84 and the passage. The steam introduction chamber 84 is provided with a steam introduction port 85, and steam is introduced into the casing 12 through the filter 86 in the form of mist having a desired uniform volume. The steam introduction ports 85, 88 may be provided with a pressure gauge (not shown) for measuring an injection pressure of steam. Thus, volume and pressure of steam can be adjusted.

As another embodiment, the steam introduction port 88 formed on the upstream-side stirring chamber 200a in the above-described casing 12 can also be used as a liquid introduction port. Also, the liquid introduction port may be provided with a flowmeter (not shown) capable of measuring an amount of the liquid to be introduced. Examples of the liquid to be introduced through the liquid introduction port include a solvent (e.g., water, alcohols) to be mixed with powder, a solvent to be reacted with powder, and the like. Here, the mixing solvent may be the same solvent as that supplied through the liquid introduction port 22 of the introduction pipe 55 shown in FIG. 1, or a different solvent. In the above embodiment, the stirring chamber 200b of the casing 12 is provided with the steam introduction chamber 84 in the same manner as above, the steam introduction chamber 84 is provided with the steam introduction port 85, and steam is introduced in the form of mist having a desired uniform volume into the casing 12 through the filter 86. The steam introduction port 85 may be provided with a pressure gauge (not shown) for measuring an injection pressure of the steam in the same manner as above. Thus, a volume of steam and a pressure of steam can be adjusted.

The stirring chamber 200c which is provided with an untreated material discharge port 64 is also provided with a filter 70 which surrounds the stirrer 15. Even if an untreated material (e.g., undissolved lump) of the raw material is present in the casing 12, only the untreated material can be discharged through the discharge port 64 by means of the filter 70. For the filter 70, for example, a stainless steel or ceramic filtering member having a microlevel mesh (fine mesh), a reverse osmosis membrane, a polymer membrane (nano filter membrane) or the like can be used. Also, a treated chamber 82 into which the filtered material is introduced is disposed outside of the filter 70 of the stirring chamber 200c, and the treated chamber 82 is provided with a treated material discharge port 62.

The untreated material discharge port 64 is provided with a pressure gauge 80 and a discharge valve 68, and the treated material discharge port 62 is provided with a discharge valve 66.

The oscillatory rotation drive source 53 will now be described with reference to FIG. 2 through FIG. 5.

The oscillatory rotation drive source 53 comprises a rotation portion for rotating the feeder 54 and an oscillation source for mainly oscillating a second shaft portion 48 as shown in FIG. 2.

As shown in FIG. 2, the rotation source comprises a first gear 34 which is connected to a motor 36 as a drive source and rotationally movable, a second gear 32 which is engaged with the first gear 34 and rotationally movable in a rotation direction opposite to that of the first gear 34, and a gear unit 30 which has the second gear 32 on its outside wall and the feeder 54 coupled to its bottom.

The oscillation source has an eccentric cam 50 which is coupled to one end of the second shaft portion 48, a piston portion 40 which is coupled to the other end of the second shaft portion 48 and fitted into the gear unit 30, and rotation preventing means which are disposed between the piston portion 40 and the gear unit 30 and prevents the rotational movement from being transmitted to the piston portion 40.

The rotation preventing means of this embodiment comprise a radial bearing 42 which is disposed between the external side wall of the piston portion 40 and the inside side wall of the gear unit 30 and a thrust bearing 44 which is disposed at least between the bottom portion of the piston portion 40 and the inside bottom portion of the gear unit 30 or between the top portion of the piston portion 40 and the opposed surface of the gear unit 30. The disposition of the radial bearing 42 makes it possible to prevent the rotational movement of the gear unit 30 to which the rotational movement is transmitted by the first gear 34 and the second gear 32 from being transmitted to the piston portion 40. Also, the disposition of the thrust bearing 44 can cause engagement of the first gear 34 and the second gear 32 and transmit the rotational movement to the gear unit 30 while easily sliding the gear unit 30 in the directions indicated by an arrow 102 in conjunction with the oscillatory movement of the piston portion 40 which is oscillated by the eccentric cam 50.

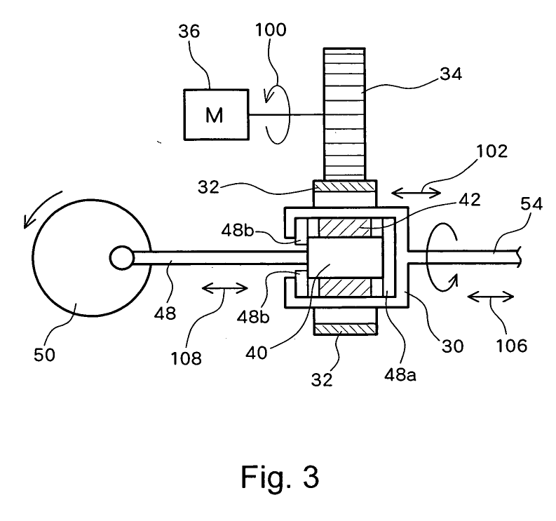

In addition to the above configuration, the oscillatory rotation drive source 53 may be configured as shown in FIG. 3. The above-described oscillatory rotation drive source of FIG. 2 has the thrust bearing 44 disposed on at least either between the bottom portion of the piston portion 40 and the inside bottom portion of the gear unit 30 or between the top portion of the piston portion 40 and the opposed surface of the gear unit 30. However, the oscillatory rotation drive source shown in FIG. 3 is provided with flat plates 48a, 48b instead of the thrust bearing 44.

The disposition of the flat plates 48a, 48b makes it possible to engage the first gear 34 and the second gear 32 to transmit the rotational movement to the gear unit 30, while easily sliding the gear unit 30 in the directions of the arrow 102 in conjunction with the oscillatory movement of the piston portion 40 which is oscillated by the eccentric cam 50.

The operation of the oscillatory rotation drive sources shown in FIGS. 2, 3 will now be described.

In the oscillatory rotation drive source 53, the eccentric cam 50 is driven to oscillate the second shaft portion 48 in directions indicated by an arrow 108 as shown in FIG. 2 or FIG. 3. Thus, the piston portion 40 which is coupled to the second shaft portion 48 oscillates in the directions of the arrow 102.

The motor 36 is driven simultaneously with or separately from the drive of the eccentric cam 50 to rotate the first gear 34 in a direction indicated by an arrow 100. Thus, the rotation of the first gear 34 is transmitted to the second gear 32 which is engaged with the first gear 34, and the second gear 32 rotates in a direction opposite to the rotation direction of the first gear 34, namely a direction of an arrow 104. As a result, the gear unit 30 which has the second gear 32 on its external side wall rotates in the direction of the arrow 104, and the feeder 54 which is coupled to the gear unit 30 also rotates in the direction indicated by the arrow 104.

In addition, the oscillatory movement of the piston portion 40 in the direction of the arrow 102 is transmitted to the gear unit 30. Thus, the feeder 54 connected to the oscillatory rotation drive source rotates in the direction of the arrow 104 and also oscillates in a direction of an arrow 106 as shown in FIGS. 2, 3.

As a result, the feeder 54 oscillates and rotates within the powder introducing device 57, and powder can be conveyed efficiently to the stirring and mixing device 110.

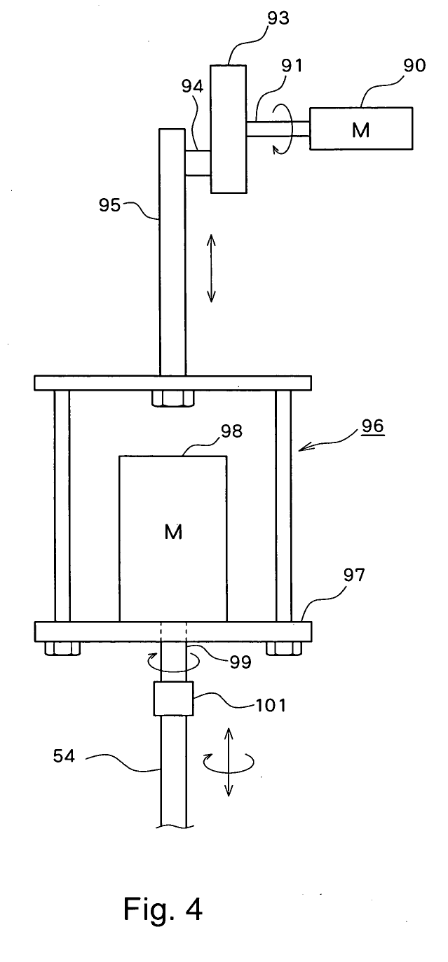

Another oscillatory rotation drive source will be described below with reference to FIG. 4. As shown in FIG. 4, the oscillatory rotation drive source has a first rotating shaft 91 which is connected to a first motor 90, an eccentric cam 93 which is connected to the first rotating shaft 91, a shaft 94 which eccentrically and rotatably supports the eccentric cam 93, an oscillating shaft 95 which is coupled to the shaft 94, a motor housing box 96 which has its one end connected to the oscillating shaft 95 and a bottom plate 97 of the other end fixed to a second motor 98, a second rotating shaft 99 which is rotatably connected to the second motor 98 through a through hole which is formed in the bottom plate 97 of the motor housing box 96, and a joint portion 101 which couples the second rotating shaft 99 and the feeder 54.

The operation of the oscillatory rotation drive source shown in FIG. 4 will now be described.

When the first motor 90 is driven, the first rotating shaft 91 rotates, the rotation of the first rotating shaft 91 is transmitted to the eccentric cam 93, the oscillating shaft 95 coupled to the shaft 94 is moved in an oscillatory manner by the rotation of the eccentric cam 93, and the motor housing box 96 is oscillated. Meanwhile, the second motor 98 fixed to the bottom plate 97 of the motor housing box 96 is driven to rotate the second rotating shaft 99 which is connected to the second motor 98 through the through hole of the bottom plate 97. Therefore, the first motor 90 and the second motor 98 are driven simultaneously to move the motor housing box 96 in an oscillatory manner, and the second rotating shaft 99 which is rotatably connected to the motor housing box 96 rotates. Then, the feeder 54 which is coupled to the second rotating shaft 99 via the joint portion 101 rotates in an oscillatory manner.

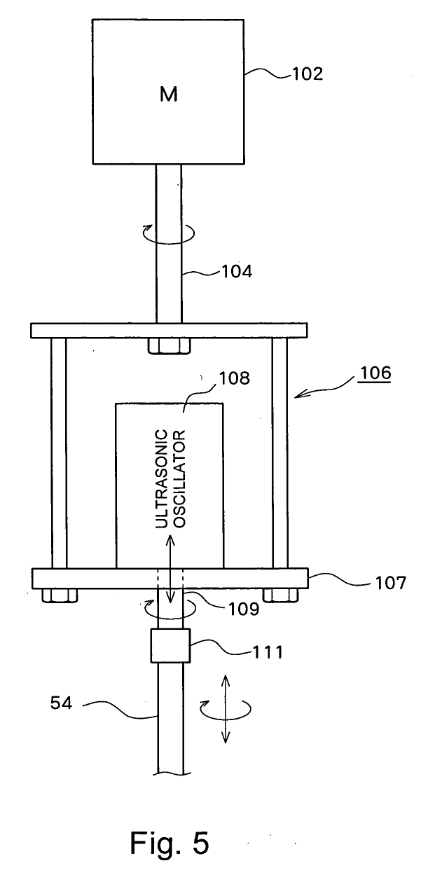

Another oscillatory rotation drive source will be described with reference to FIG. 5. As shown in FIG. 5, the oscillatory rotation drive source has a rotating shaft 104 which is fitted to a motor 102, a motor housing box 106 which has its one end connected to the rotating shaft 104 and an ultrasonic oscillator 108 fixed to a bottom plate 107 of the other end, an oscillating shaft 109 which is coupled with the bottom plate 107 of the motor housing box 106, and a joint portion 111 which couples an oscillating shaft 99 and the shaft portion 14 and/or the feeder 54. Here, the ultrasonic oscillator 108 may be a piezo element.

Operation of the oscillatory rotation drive source shown in FIG. 5 will now be described.

The motor 102 is driven to rotate the rotating shaft 104, and the rotation of the rotating shaft 104 causes the motor housing box 106 to rotate. Meanwhile, the ultrasonic oscillator 108 which is fixed to the bottom plate 107 of the motor housing box 106 is oscillated, and the oscillating shaft 109 which is connected to the bottom plate 107 of the motor housing box 106 is oscillated. Thus, the motor 102 and the ultrasonic oscillator 108 are driven simultaneously, the motor housing box 106 rotates, and the oscillating shaft 109 connected to the motor housing box 106 oscillates. Thus, the feeder 54 which is coupled to the oscillating shaft 109 via the joint portion 111 rotates in an oscillatory manner.

Using the oscillatory rotation drive source 53 configured as described above, powder can be delivered from the powder introducing device 57 to the introduction pipe 55 without substantially disrupting the flow of the powder. Even if powder and liquid which are introduced in the vicinity of the introduction port of the powder introducing device 57 are contact each other and adhere to the feeder 54, the feeder-adhered material can be separated from the feeder 54 by the oscillatory rotation drive source 53. Therefore, secondary aggregation can be prevented from taking place at the time of later stirring and mixing, and the stirring operation can be performed smoothly.

Then, an operation of the stirring and mixing device 110 of this embodiment will be described.

The oscillatory rotation drive source 53 is driven to extrude powder from the powder introducing device 57 to the introduction pipe 55 by the feeder 54. Meanwhile, liquid 78 is introduced from the liquid storage tank 76 into the introduction pipe 55 through the liquid introduction port 22 via the pump 74 and the valve 72.

Here, the powder and the liquid are brought into contact to form a mixture of aggregates, and the mixture is introduced into the extrusion pipe 60. The motor 63 is driven to rotate the rotor 61 in the extrusion pipe 60 to extrude the mixture toward the casing 12.

The extruded mixture is introduced into the upstream stirring chamber 200a of the casing 12, stirred and mixed while being continuously conveyed to the stirring chambers 200b, 200c by the stirring and mixing operation of the stirrer 15 driven by the drive source 20 and altered from an aggregate to a homogeneous fluid.

Also, the stirred material which is continuously delivered through the stirring chambers 200a, 200b, 200c of the stirring and mixing device 110 is filtered by the filter 70, and the filtered material is stored in the treated chamber 82 and discharged through the treated material discharge port 62 with the valve 66 operated manually or automatically from close to open anytime or continuously. Meanwhile, when the pressure gauge 80 disposed at the untreated material discharge port 64 indicates a prescribed pressure or more, the valve 68 is operated from close to open manually or automatically to discharge the untreated material.

Steam is introduced through the steam introduction port 88 of the stirring chamber 200a and/or the steam introduction port 85 of the stirring chamber 200b in the casing 12, and the mixture introduced into the casing 12 can be heated and/or dissolved and/or sterilized by adjusting a steam amount and/or a steam pressure. Also, the viscosity or reaction of the mixture can be adjusted by adjusting the steam amount and/or the steam pressure.

For the above-described extrusion pipe 60, a Mohno pump was used, but this is not exclusive. For example, a commercially available centrifugal pump, slurry pump or tube pump can be used.

As another embodiment, when the steam introduction port 88 of the stirring chamber 200a in the casing 12 is used as a liquid introduction port, a solvent (e.g., water or alcohol) to be mixed with powder can be introduced through the liquid introduction port, mixed and stirred with the mixture which is introduced into the casing 12 to adjust the viscosity of and the dilution rate of the mixture. Also, when the steam introduction port 88 is used as a liquid introduction port and the solvent to be reacted with the power is introduced through the liquid introduction port, the mixture introduced into the casing 12 and the solvent are stirred to promote the reaction. As described above, the above-described mixing solvent may be the same solvent as that supplied through the liquid introduction port 22 of the introduction pipe 55 shown in FIG. 1 or a different solvent.

In this embodiment, the mixture is conveyed from the upper portion to the lower portion of the casing 12 in FIG. 1, but this is not exclusive. The structure of the casing of FIG. 1 may be changed upside down to convey the mixture from the lower portion toward the upper portion.

According to the present invention, the liquid introduction port is disposed below the vicinity of the powder introduction port, so that the powder to be introduced can be delivered to spread downward, and the feeder is rotated in an oscillatory manner to introduce the powder into the introduction pipe. Thus, the introduced liquid comes into contact with the powder which is present in the vicinity of the powder introduction port of the introduction pipe, and even if a deposit due to secondary aggregation of the powder and the liquid adheres to the feeder, the deposit can be removed from the feeder. Besides, the feeder can be rotated in an oscillatory manner to introduce the secondary aggregate into the introduction pipe anytime or continuously through the powder introduction port. Thus, lumps of the secondary aggregate can be prevented from increasing in size over time, and the powder introduction port can be prevented from being blocked by a very-large secondary aggregate.

The stirring and mixing device of the present invention can be applied to usages when stirring and mixing are required to be performed uniformly and smoothly because mixing tends to cause secondary aggregation, a stirred material has high viscosity, or the like.

What is claimed is:

1. A stirring and mixing device having an introduction pipe comprising a powder introduction port, at least one liquid introduction port which is disposed below the vicinity of the powder introduction port, a feeder which conveys powder and a mixture of powder and liquid, and an oscillatory rotation drive source which rotates the feeder in an oscillatory manner.

2. The stirring and mixing device according to claim 1, wherein:
the feeder is provided with a powder delivery screw blade at least at the position of the liquid introduction port or below the position of the liquid introduction port, and
the powder delivery screw blade has a size such that its side end portion reaches the vicinity of the inside wall of the introduction pipe.

3. The stirring and mixing device according to claim 1, wherein the feeder is provided with at least one cutting blade for cutting the mixture of powder and liquid.

4. The stirring and mixing device according to claim 2, wherein the feeder is provided with at least one cutting blade for cutting the mixture of powder and liquid.

5. The stirring and mixing device according to claim 1, further comprising:
an overflow port which is disposed below the powder introduction port and above the liquid introduction port.

6. The stirring and mixing device according to claim 2, further comprising:
an overflow port which is disposed below the powder introduction port and above the liquid introduction port.

7. The stirring and mixing device according to claim 3, further comprising:
an overflow port which is disposed below the powder introduction port and above the liquid introduction port.

8. The stirring and mixing device according to claim 4, further comprising:
an overflow port which is disposed below the powder introduction port and above the liquid introduction port.

9. The stirring and mixing device according to claim 1, further comprising:
an extrusion pipe which is connected to one end portion of the introduction pipe and extrudes the mixture of powder and liquid, which is introduced through the introduction pipe, to one end portion,
a casing which is connected to the extrusion pipe and provided with a passage through which a fluid of the extruded mixture is made to flow, and
a stirrer which is disposed within the casing and comprised of a shaft portion connected to an oscillation source and a stirring blade attached to the external surface of the shaft portion.

10. The stirring and mixing device according to claim 2, further comprising:
an extrusion pipe which is connected to one end portion of the introduction pipe and extrudes the mixture of powder and liquid, which is introduced through the introduction pipe, to one end portion,
a casing which is connected to the extrusion pipe and provided with a passage through which a fluid of the extruded mixture is made to flow, and
a stirrer which is disposed within the casing and comprised of a shaft portion connected to an oscillation source and a stirring blade attached to the external surface of the shaft portion.

11. The stirring and mixing device according to claim 3, further comprising:
an extrusion pipe which is connected to one end portion of the introduction pipe and extrudes a mixture of powder and liquid, which is introduced through the introduction pipe, to one end portion,
a casing which is connected to the extrusion pipe and provided with a passage through which a fluid of the extruded mixture is made to flow, and
a stirrer which is disposed within the casing and comprised of a shaft portion connected to an oscillation source and a stirring blade attached to the external surface of the shaft portion.

12. The stirring and mixing device according to claim 4, further comprising:
an extrusion pipe which is connected to one end portion of the introduction pipe and extrudes a mixture of powder and liquid, which is introduced through the introduction pipe, to one end portion,
a casing which is connected to the extrusion pipe and provided with a passage through which a fluid of the extruded mixture is made to flow, and
a stirrer which is disposed within the casing and comprised of a shaft portion connected to an oscillation source and a stirring blade attached to the external surface of the shaft portion.

13. The stirring and mixing device according to claim 5, further comprising:
an extrusion pipe which is connected to one end portion of the introduction pipe and extrudes a mixture of powder and liquid, which is introduced through the introduction pipe, to one end portion,
a casing which is connected to the extrusion pipe and provided with a passage through which a fluid of the extruded mixture is made to flow, and
a stirrer which is disposed within the casing and comprised of a shaft portion connected to an oscillation source and a stirring blade attached to the external surface of the shaft portion.

14. The stirring and mixing device according to claim 6, further comprising:
an extrusion pipe which is connected to one end portion of the introduction pipe and extrudes a mixture of powder and liquid, which is introduced through the introduction pipe, to one end portion,
a casing which is connected to the extrusion pipe and provided with a passage through which a fluid of the extruded mixture is made to flow, and
a stirrer which is disposed within the casing and comprised of a shaft portion connected to an oscillation source and a stirring blade attached to the external surface of the shaft portion.

15. The stirring and mixing device according to claim 7, further comprising:
an extrusion pipe which is connected to one end portion of the introduction pipe and extrudes a mixture of powder and liquid, which is introduced through the introduction pipe, to one end portion,
a casing which is connected to the extrusion pipe and provided with a passage through which a fluid of the extruded mixture is made to flow, and
a stirrer which is disposed within the casing and comprised of a shaft portion connected to an oscillation source and a stirring blade attached to the external surface of the shaft portion.

16. The stirring and mixing device according to claim 8, further comprising:
an extrusion pipe which is connected to one end portion of the introduction pipe and extrudes a mixture of powder and liquid, which is introduced through the introduction pipe, to one end portion,
a casing which is connected to the extrusion pipe and provided with a passage through which a fluid of the extruded mixture is made to flow, and
a stirrer which is disposed within the casing and comprised of a shaft portion connected to an oscillation source and a stirring blade attached to the external surface of the shaft portion.

17. The stirring and mixing device according to claim 9, wherein:
the feeder is further comprised of a first shaft portion and a second shaft portion, and
the oscillatory rotation drive source is comprised of a rotation source for rotating the first shaft portion and an oscillation source for oscillating the second shaft portion.

18. The stirring and mixing device according to claim 9, wherein at least one stirring chamber is disposed within the casing by dividing the passage by a partition plate.

19. The stirring and mixing device according to claim 9, wherein:
the casing is further provided with a discharge port, and
a filter for filtering the content of the casing is disposed in the vicinity of the discharge port.

20. The stirring and mixing device according to claim 9, further comprising:
at least one steam introduction port through which steam is introduced into the casing.

21. The stirring and mixing device according to claim 9, wherein the mixture introduced into the casing is heated and/or dissolved and/or sterilized by adjusting an amount of steam and/or a pressure of steam.

22. The stirring and mixing device according to claim 9, wherein viscosity or reaction of the mixture is adjusted by adjusting an amount of steam and/or a pressure of steam.

23. The stirring and mixing device according to claim 9, further comprising:
at least one liquid introduction port through which the liquid is introduced into the casing.

24. The stirring and mixing device according to claim 23, wherein the viscosity or reaction of the mixture is adjusted by adjusting the amount of the liquid to be introduced.
